(19) United States
(12) Patent Application Publication
(10) Pub. No.: US 2025/0245888 A1
(43) Pub. Date: Jul. 31, 2025

(54) SYSTEM FOR CONTEXTUAL IMAGE EDITING

(71) Applicant: Microsoft Technology Licensing, LLC, Redmond, WA (US)

(72) Inventors: Mina DOROUDI, Redmond, WA (US); Stephanie Lorraine HORN, Bellevue, WA (US); Rolly SETH, Redmond, WA (US); Priyanka Vikram SINHA, Sunnyvale, CA (US); Brittany Elizabeth MEDEROS, Santa Clara, CA (US); Ian Dwyer CURRY, Seattle, WA (US); Aparna CHENNAPRAGADA, Redmond, WA (US); Derek Martin JOHNSON, Sunnyvale, CA (US); Dachuan ZHANG, Sunnyvale, CA (US)

(21) Appl. No.: 18/677,087

(22) Filed: May 29, 2024

Related U.S. Application Data
(60) Provisional application No. 63/626,887, filed on Jan. 30, 2024.

(51) Int. Cl. G06T 11/60; G06F 3/0482; G06F 3/04845

(52) U.S. Cl. CPC G06T 11/60; G06F 3/0482; G06F 3/04845

(57) ABSTRACT

Systems, methods, and software are disclosed herein for a system by which a user can edit an image, such as an AI-generated image, using contextualized editing on an intelligent image canvas. In an implementation, a computing device receives an image generated by a generative artificial intelligence model in response to a prompt which includes a natural language request from a user. The computing device displays an image canvas of the image including multiple segments of the image which were identified by a segmentation model. The computing device displays a context menu of options to edit the image based on a selection of a segment of the image by the user. In an implementation, the computing device also displays a context menu of options to edit the image.

### CROSS REFERENCE TO RELATED APPLICATION

This application is related to U.S. patent application entitled “SYSTEM FOR CONTEXTUAL IMAGE EDITING,” (U.S. Patent Application No. 63/626,887) filed Jan. 30, 2024, the contents of which is incorporated by reference in its entirety for all purposes.

### TECHNICAL FIELD

Aspects of the disclosure are related to the field of digital image editing and artificial intelligence models for creating and editing images.

### BACKGROUND

Generative artificial intelligence models, such as GPT-4V, Dall-E, Stable Diffusion, and the like, are capable of rapidly generating imagery in response to effective prompting. However, using these models for image generation and editing often relies on carefully thought-out natural language prompts. When a generative AI model receives a natural language prompt that is vague or unclear or leaves out important details, the output generated by the model will likely reflect that uncertainty or imprecision, leading the user to continually refine the language of the prompt in order to generate the desired output. Thus, users who are unfamiliar with generative AI models or who lack experience interacting with them are often at a disadvantage in using the models to generate content. But even experienced users may not be able to fully exploit a model's capabilities if they are unaware of every capability that the model has.

To generate the desired output, a user may engage in a multi-turn conversational exchange with the generative AI model until the user gets useful content, but this can be time-consuming, may consume an excessive amount of processing resources, and may distract the user from the user's primary task. For example, when an interaction with an AI model is begun, if the model gets off to a false start, the user may fruitlessly try to steer the model back onto the right track before starting over with a new conversation. Strategies have evolved to improve the effectiveness of users' prompts. For example, a user may resort to canned prompts to generate content, but this undercuts the ability of the models to generate unexpectedly creative content. Other strategies include using fine-tuned models for image generation, but this narrows the scope with regard to the type of output that can be generated. As a result of these limitations, these models may be underutilized for image generation and editing.

### Overview

Technology is disclosed herein for a system by which a user can edit an image, such as an AI-generated image, using contextualized editing on an intelligent image canvas. In an implementation, a computing device receives an image generated by a generative artificial intelligence model in response to a prompt which includes a natural language request from a user. The computing device displays an image canvas of the image including multiple segments of the image which were identified by a segmentation model. The computing device displays a context menu of options to edit the image based on a selection of a segment of the image by the user. In an implementation, the computing device also displays a context menu of options to edit the image.

In an implementation, the context menu includes an option for editing the segment based on a semantic understanding of the of the segment identified by the segmentation model. In an implementation, the computing device prompts the generative AI model to regenerate the image based on the selection of an option in the context menu. In an implementation, the computing device edits the selected segment of the image based on the selection of an option in the context menu.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for visual image editing in an implementation.

FIG. 2 illustrates a process for visual image editing in an implementation.

FIG. 3 illustrates an operational environment for visual image editing in an implementation.

FIG. 4 illustrates an operational scenario for visual image editing in an implementation.

FIG. 5 illustrates a workflow for visual image editing in an implementation.

FIGS. 6A and 6B illustrate a user experience for visual image editing in an implementation.

FIGS. 7A-7E illustrate a user experience for visual image editing in an implementation.

FIG. 8 illustrates a user experience for visual image editing in an implementation.

FIG. 9 illustrates a computing system suitable for implementing the various operational environments, architectures, processes, scenarios, and sequences discussed below with respect to the other Figures.

### DETAILED DESCRIPTION

Various implementations are disclosed herein for a system by which users can edit images, such as an AI-generated image, using contextualized editing on an intelligent image canvas. In various implementations, the user is presented with a conversational framework, such as a chat interface, where the user can enter text-based natural language requests and visually edit an image displayed as an intelligent image canvas. The intelligent image canvas displays the image in the interface as made up of multiple distinct image segments (e.g., areas or objects in the image) based on semantic recognition of the image content. For example, an object in the foreground of the image is a distinct segment from one or more background areas or objects of the image. To edit the image, as the user selects a segment of the intelligent image canvas, the interface displays a context-aware menu of editing options or suggestions which are appropriate for that segment. The interface can also be prompted to display options for editing the entire image of the intelligent image canvas itself when the user selects a canvas editing button.

In an implementation, as the user hovers over a segment of an image, the application identifies the segment and visually highlights the segment on the intelligent canvas. The application may also display a brief comment or suggestion to the user in reference to editing the image. The application also surfaces a contextualized menu of options for editing the segment. With the segment selected, the user can choose an editing option from the menu. In a brief example, a segment may be an object in the image (e.g., a dog, a tree). Options for editing the object can include erasing the object, regenerating the object to modify it or to transform the object into something different, repositioning the object to another location in the image, creating multiples of the object, or adjusting the lighting of, color of, or focus on the object. If, for example, the user desires to remove the object from the image, the user can select the object and select the erase tool or option from the context menu.

In some cases, the user may want to change the image as a whole. For example, when the user hovers over or selects a canvas editing button, the application may surface options for changing the drawing style of the image (e.g., photorealistic, pen and ink, cartoon). The user may also select a segmented object in the image and select editing options to be applied to the unselected segments of the image, such as blurring the background of the image. In some scenarios, the application recognizes the object type and surfaces more specific options or suggestions based on the type. For example, if the segment includes a person, the editing options may include refilling the segment to change the person's clothing or stance. If the segment includes a dog, the editing options may include changing the size or breed.

When the user selects an image editing option for a segment of an image, the application hosting the interface accesses one of various engines or tools for performing the requested edit. For example, if the user requests that a segmented object be erased, the application may prompt an AI image editing model or engine to redraw the segment without the object. If the user opts to blur the background of the image, the application may access an image editing toolkit and apply a blurring tool to the background segments. And if the user requests that the image be resized (for example, to change the image proportions), the application may generate a prompt for the generative AI model to regenerate the image accordingly. In this way, the user can visually edit the image using a variety of image editing techniques without having to formulate a natural language request to do so. Rather, the application presents to the user contextually appropriate editing options to edit the image segment by segment or the image in its entirety, thus allowing the user finer control over the editing process in a fluid and intuitive manner.

In an implementation, an application hosts a chat interface for image creation and editing via natural language dialog or contextualized visual editing. A user may enter a natural language request in the interface which describes the user's desired image for submission to a generative AI model trained for image generation. The generative AI model may return multiple images from which the user can select the image closest to the user's desired image. When the application receives the user's selection of an image, the image is submitted to a segmentation model. The segmentation model, such as an AI model trained for object detection, identifies or recognizes objects or areas in the image and segments the objects or areas until the image is fully defined in terms of segmented objects and areas. In some scenarios, the segmentation model may be trained for image classification to identify the types of objects in the image. The segmentation map generated by the segmentation model forms the basis of the intelligent image canvas which is displayed in a larger format in the interface.

In some implementations, when the segmentation model processes the selected image, the application may display a placeholder image which indicates to the user that the image is being processed for display. The placeholder image may itself be interactive to maintain the user's engagement with the editing process, such as displaying an abstract style of graphic which is animated in response to the user's pointer or cursor moving over it. In some implementations, the array of images generated by the generative AI model in response to the prompt may be segmented prior to display in the interface, thus before the user selects an image for further development. With the selected image previously mapped by the segmentation model, the user can begin the editing process without having to wait for the selected image to be processed. However, the time to process an array of images rather than a single image may outweigh the benefit of moving immediately from image selection to the editing phase.

Having received the segmentation map of the image from the segmentation model, the application displays the intelligent image canvas in the interface. The user can interact with the intelligent canvas in the interface by, say, hovering the user's input device over a segment or clicking on a segment to select it. As the user hovers over a segment, the intelligent canvas highlights the segment to make the segment visually distinct from the surrounding segments and may display a textual suggestion related to editing the segment or the image. When the user selects a segment, the application displays a contextualized menu of options by which the user can edit the segment, such as erasing the segment or recoloring the segment, or options to edit other segments of the image, such as rendering the other segments in grayscale to make the selected segment (in color) stand out. When the user has performed all the desired edits or achieved an acceptable version of the image, the user can save, send, or export the image or insert the image into a document or file, such as to a word processing document, slide presentation, project canvas, webpage, etc.

In an implementation, when the user has selected an image for editing, the image is processed by the segmentation model to generate a segmentation map on which the intelligent image canvas is based. The segmentation model may be hosted by the application or by a service external to the application which communicates with the application via an application programming interface (API). The segmentation map of the image received from the segmentation model comprises multiple segments which correspond to areas or objects of the image that were semantically recognized by the segmentation model. In various scenarios, the entire image is segmented into nonoverlapping segments. The segments may be contiguous (e.g., a single object, such as a person in the image) or disjointed (e.g., multiple separate objects, such as leaves falling from a tree). The processed image may also include contextual information for each of the segments, such as an identification of the type of segment (e.g., foreground or background), an object label or classification (e.g., sky, dog, tree), and other information pertinent to editing the segment, such as identifying multiple objects of the same type to allow for simultaneous editing by type.

The interface for contextualized image editing via an intelligent image canvas along with text-based interaction with an AI model can be hosted in applications where users may wish to generate custom imagery or incorporate custom imagery in a project. In an implementation, the interface for contextualized editing of an image is hosted by an application for image creation and editing. The application may include a prompt engine to receive a user's natural language request (keyed in or spoken to a speech-to-text translator, for example), generate a prompt for submission to a generative AI model trained for image generation, and receive a response from the model based on the prompt. Alternatively, the application may receive existing images for contextualized editing, such as images dropped into the interface by the user. In some scenarios, the contextualized editing interface is an application tool or assistant of a productivity application, such as word processing application or slide presentation application, or a browser application. In addition to communicating with a generative AI model to create and edit images, the application may also interface with other deep learning models for image editing or large language models for other types of user queries.

To perform the edits selected by the user, the application may access the generative AI model which created the image, an AI engine of the application, other generative AI models different from the model which created the image, or an image editing toolkit. In an implementation, the application maps the types of edits in a contextual menu to a model or tool for performing the edit. Thus, when the user selects a particular type of edit, the application requests the edit from the model or tool corresponding to the edit. For edits which encompass the entire image, such as resizing the image or changing the style of the image, the application may generate a prompt which tasks the generative AI model to regenerate the model according to the selected edit. For segment-level edits, i.e., edits to one or more segments of the image, the application may task a different generative AI model to regenerate the segments or the image according to the selected edit. For edits which change the visual character of the segment (e.g., color saturation, focus, lighting), the application may use an image editing tool or filter of an image editing toolkit. Although the application uses different models or tools to perform the various edits, the user interface presents a seamless display of the editing options.

In some implementations, the application receives contextual information about a segment in the segmentation map and determines which edits may be presented in the contextual menu for the segment. For example, the segmentation map may include classification information about a segment according to which the application selects suitable editing tools specifically for the segment. The application may include a default set of editing tools to be presented to the user but may also display editing options which were selected based on an aspect of a segment unique to that segment, e.g., the type or classification of the object or area which has been segmented.

In some implementations, the interface may present the image canvas for image-level editing without segmentation. That is to say, the user can edit the image as a whole (e.g., changing the style or the size of the image) in the interface using text-based inputs or selections of editing options from a contextual menu displayed with the image. For example, the user may enter a text-based request for an image. The application prompts the generative AI model to create one or more images responsive to the user's request. The application presents the images generated by the model in the interface where the user can select an image for editing. With an image selected, the application displays the image in a larger format along with a contextual menu of editing options by which the user can edit the image using the pointer. The user may also enter textual requests to edit the image, such as if the editing option the user desires is not in the menu.

Generative AI models for image generation of the technology disclosed herein, such as DALL-E and its brethren, combine elements of large language models and image generation to generate highly realistic and novel images from textual descriptions. Such models, including vision comprehension models and object segmentation models, may be trained on a dataset containing pairs of images and their textual descriptions. During training, the model learns to generate images conditioned on textual prompts. The model uses a decoder to convert the textual input into an image, pixel by pixel, by sampling from a large discrete set of possible image elements. The model can learn to generate images that align with the given textual descriptions which have not been seen in the training dataset.

In some scenarios, the application or interface for performing visual editing may also communicate with a large language model (LLM). LLMs, such as GPT-3, GPT-4 and the like, are a type of deep learning AI model which processes and generates natural language text. These models are trained on massive amounts of text data and learn to generate coherent and contextually relevant responses given a prompt or input text. LLMs are capable of understanding and generating sophisticated language based on their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Technical effects of the technology disclosed herein include an interface by which a user can edit an image using generative AI models. The interface presents the user with a context-aware selection of editing tools or options to assist the user in achieving the most desirable image product. By integrating visual editing (i.e., editing by interacting with the image using a cursor) in a chat interface, the user can request edits in a streamlined and more fluid interaction than having to formulate and key in a natural language request. Moreover, by presenting a menu of editing options, the user need not be practiced in the use of editing tools nor knowledgeable in editing terminology to achieve sophisticated outcomes.

In addition, the application consolidates the use of multiple different types of editing tools and engines, ranging from basic editing tools and filters for modifying color, lighting, focus, and so on, to powerful AI engines for regenerating individual segments of an image or the entire image. Thus, the user can step through a wide range of image revisions in a single interface, but which are selectively presented according to the user's interaction with the image.

Further, the interface can be presented as a stand-alone application for image creation and editing or as an integration in other applications. Thus, the user can generate a desired image for a project, such as writing a book or creating a slide presentation, within the application hosting the project and without having to open a second application.

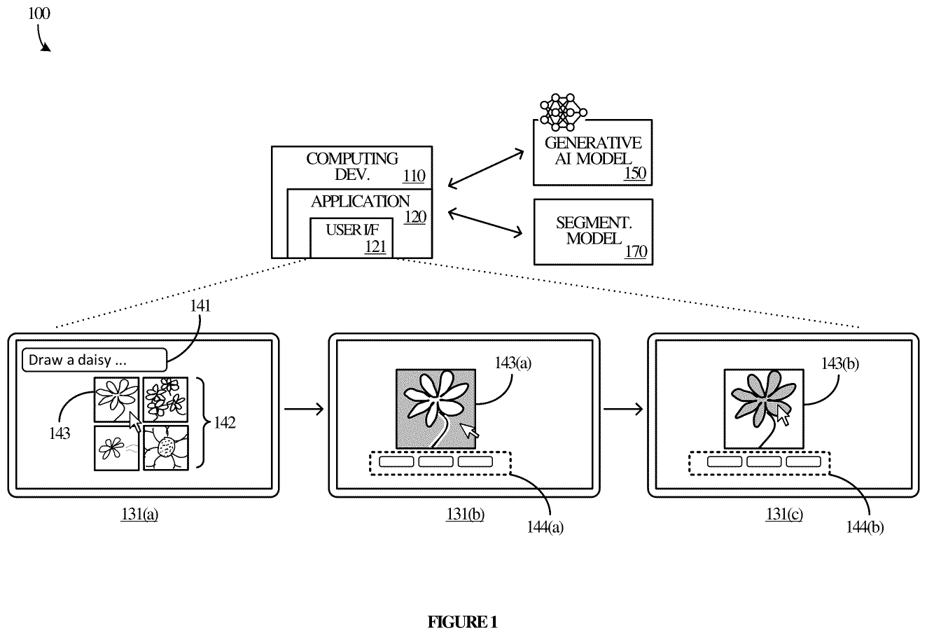

Turning now to the Figures, FIG. 1 illustrates operational environment 100 for contextual image editing in an implementation. Operational environment 100 includes computing device 110 which hosts application 120 including user interface 121. User interface 121 displays user experiences 131(a)-(c) of application 120. Computing device 111 is in communication with generative AI model 150, including sending prompts to generative AI model 150 and receiving output generated by the model according to its training.

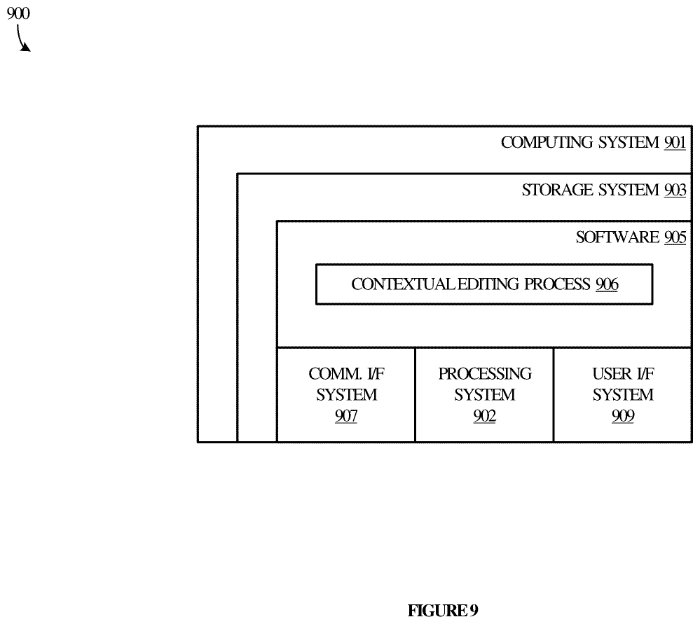

Computing device 110 is representative of a computing device, such as a laptop or desktop computer, or mobile computing device, such as a tablet computer or cellular phone, of which computing system 901 in FIG. 9 is broadly representative. Computing device 110 communicates with generative AI model 150 via one or more internets and intranets, the Internet, wired or wireless networks, local area networks (LANs), wide area networks (WANs), and any other type of network or combination thereof.

Application 120 is representative of a software application by which a user can create and edit an image and which can generate prompts for submission to generative AI models, such as generative AI model 150. Application 120 may execute locally on a user computing device, such as computing device 110, or application 120 may execute on one or more servers in communication with computing device 110 over one or more wired or wireless connections, causing user interface 121 to be displayed on computing device 110. In some scenarios, application 120 may execute in a distributed fashion, with a combination of client-side and server-side processes, services, and sub-services. For example, the core logic of application 120 may execute on a remote server system with user interface 121 displayed on a client device. In still other scenarios, computing device 110 is a server computing device, such as an application server, capable of displaying user interface 121, and application 120 executes locally with respect to computing device 110. In various implementations, application 120 may include an image editing toolkit including various editing tools (e.g., tools, effects, filters) by which application 120 can edit an image or a segment of an image.

Application 120 executing locally with respect to computing device 110 may execute in a stand-alone manner, within the context of another application such as a presentation application or word processing application, or in some other manner entirely. In an implementation, application 120 hosted by a remote application service and running locally with respect to computing device 110 may be a natively installed and executed application, a browser-based application, a mobile application, a streamed application, or any other type of application capable of interfacing with the remote application service and providing local user experiences displayed in user interface 121 on the remote computing device.

Computing device 110 executes application 120 locally which provides a local user experience, as illustrated by user experiences 131(a)-(c) via user interface 121. Application 120 running locally with respect to computing device 110 may be a natively installed and executed application, a browser-based application, a mobile application, a streamed application, or any other type of application capable of interfacing with generative AI model 150 and providing a user experience displayed in user interface 121 on computing device 110. Application 120 may execute in a stand-alone manner, within the context of another application, or in some other manner entirely.

In user interface 121, user experiences 131(a)-(c) are representative of a local user experience hosted by application 120 in an implementation. In user experience 131(a), a chat interface is displayed including input 141 received from a user. Output generated by generative AI model 150 in response to a prompt from application 120 is displayed as image array 142. Image array 142 includes images generated by generative AI model 150 in response to the prompt including the user's natural language request in input 141.

Generative AI model 150 is representative of a deep learning model trained in image generation or generative pretrained transformer (GPT) computing model or architecture, such as Dall-E or GPT-4/4V. Generative AI model 150 is hosted by one or more computing services which provide services by which application 120 can communicate with generative AI model 150, such as an application programming interface (API). In communicating with application 120, generative AI model 150 may send and receive information (e.g., prompts and replies to prompts) in data objects, such as JavaScript Object Notation (JSON) objects. Generative AI model 150 may be implemented in the context of one or more server computers co-located or distributed across one or more data centers.

Segmentation model 170 is representative of a deep learning or neural network-based model for analysis of visual content, including segmentation of an image according to a semantic understanding of the image. Using its semantic understanding, segmentation model 170 categorizes distinct, meaningful objects or regions within an image to generate a segmentation map of the image. The segmentation map provides a pixel-wise understanding of the spatial distribution of different objects or regions within an image. Based on its semantic understanding capabilities, segmentation model 170 recognizes patterns, textures, and shapes that are indicative of different objects or regions. The segmentation map generated by segmentation model 170 includes a pixel-wise classification which assigns each pixel in the image to a segment. In various implementations, the segmentation model 170 returns a label or classification of each segment along with a delineation of segment boundaries. Segmentation model 170 may communicate with application 120 to receive images and return segmentation maps via an API hosted by the model or a service hosting the model.

A brief operational scenario of operational environment 100 follows. A user of computing device 110 interacts with application 120 hosting user experiences 131(a)-(c) via user interface 121. As illustrated in user experience 131(a), the user has entered input 141 including a natural language request for an image. Upon receiving input 141, application 120 generates a prompt including input 141 which tasks generative AI model 150 with creating an image according to input 141. Generative AI model 150 returns a response to the prompt which is displayed in user experience 131(a) as image array 142. Image array 142 includes four images generated by generative AI model 150 in response to the prompt.

As presented in user experience 131(a), the user selects image 143 of image array 142 as being closest to the user's desired image. Application 120 receives the user selection and sends image 143 to segmentation model 170 for processing. Segmentation model 170 maps image 143 into multiple segments based on its semantic recognition of the contents of the image. Segmentation model 170 returns a segmentation map of image 143 which application 120 uses to display image 143 as an intelligent image canvas, depicted as canvases 143(a) and 143(b) of user experiences 131(b) and 131(c). As illustrated, the segments defined by segmentation model 170 in canvases 143(a) and 143(b) may include the flower, the stem, and the background. (Although three segments are depicted, it may be appreciated that the number of segments mapped by the segmentation model may vary according to the complexity of an image's subject matter.) Segmentation model 170 may also return information relating to the type or content of each segment for further use by application 120, such as identifying the flower segment as an object, as a foreground object, as a flower-type object, as a flower-type object in the foreground of the image, etc.

In user experience 131(b), image 143 is displayed as canvas 143(a). The user can interact with canvas 143(a) to highlight or select different segments which make up image 143. For example, as illustrated, by hovering the cursor over or selecting the background segment of the image, the segment is visually highlighted and context menu 144(a) is displayed below the image. In context menu 144(a), the user is presented with options for editing the highlighted segment of canvas 143(a) or the segments surrounding the highlighted segment. The options for editing the highlighted segment include various types of image editing (e.g., adjustments to color, focus) as well as more sophisticated options such as changing the style of the background or even the content of the background. When the user selects an option to edit canvas 143(a) from context menu 144(a), application 120 executes the edit by prompting generative AI model 150 to regenerate the model, by prompting a second generative AI engine (not shown) to perform selective edits on canvas 143(a), or by accessing an image editing toolkit (not shown) to edit the image. Similarly, in canvas 143(b) of user experience 131(c), when the user hovers the cursor over the flower segment, the segment is highlighted and context menu 144(b) is displayed, presenting options for editing the image relative to the highlighted segment.

In various implementations, context menus 144(a) and 144(b) may present image editing options which are specific to information about the segment returned by segmentation model 170, such as identifying the highlighted segment as a foreground, midground, or background segment, the identified content or subject matter of the segment, and so on. As the user selects editing options from context menus 144(a) or 144(b), application 120 edits the image using its own internal image editing tools or prompts generative AI model 150 (or another generative AI engine for image editing) to regenerate segments of the image or the entire image according to the selected edit. To the user, the options to edit image 143 are presented as options in context menus 144(a) and 144(b) which are agnostic to which model, tool, or filter used to perform the various edits.

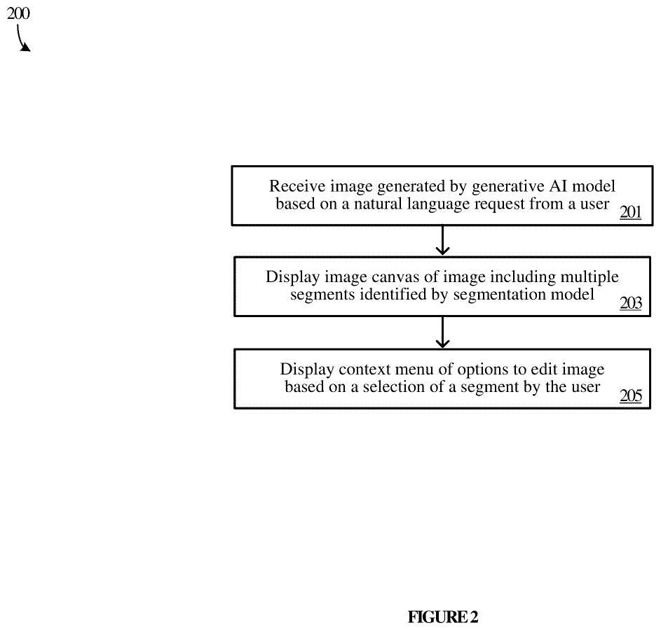

FIG. 2 illustrates a method for contextual image editing in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

A computing device receives an image that was generated by a generative AI model based on a natural language request from a user (step 201). In an implementation, a user may enter a natural language request for an image in a chat interface of an application. Upon receiving the request, the computing device generates a prompt for a generative AI model to generate one or more images responsive to the request. The AI model may return multiple images comprising various ways that the model has responded to the request. The computing device displays the multiple images in the interface and receives a selection by the user of an image to be further developed.

In some implementations, the computing device may receive the image as uploaded by the user from a storage location, such as the user's cloud or local storage or from an external source, such as a website. In various implementations, the image received by the computing device may be a photograph, a digital rendering created by the user, or some other image which was not created by a generative AI model. For example, the computing device may display a dialog box by which the user can drag-and-drop a file of the desired image for editing. The contextual menu options for editing the image may be selected by the application based on the type of image that the user supplies and the types of tools or models which are available for the image type.

The computing device displays an image canvas of the image including multiple segments identified by a segmentation model (step 203). In an implementation, the application sends the image to a segmentation model which generates a segmentation map of the image based on its semantic understanding of the image content. The segmentation may return information which delineates the borders of each segment and/or a classification of the image pixels according to which segment each pixel belongs. The segmentation map may also identify characteristics of each segment and/or classification information about the content of each segment, such as labeling a segmented object according to what the model perceives the object to be or classifying a segment as including a foreground, midground, or background content. The segmentation map may also identify segments which are disjointed, that is, segments which are composed of multiple separate regions of the image.

When the application receives the segmentation map, the application displays an image canvas based on the segmentation map. The image canvas allows the user to access context menus of editing options according to the segment selected by the user. The context menu for a given segment includes options for editing that segment, such as erasing the segment, regenerating the segment with new content, changing the look or style of the segment, and so on. The user may also be presented with options to modify other segments than the selected segment, such as modifying the other segments in such a way as to make the selected segment stand out. The context menu may also include options for editing a segment which are uniquely applicable to that segment and which may not be applicable to other segments of the image. For example, if the segmentation model has labeled a segment type or content as “cat,” the context menu may include options which relate to editing the cat's features, such as changing the color of its coat, its position or activity, and so on. Or, if the segmentation model has labeled a segment as “automobile,”, the context menu may include options which relate to changing the type or characteristics of the automobile (e.g., changing a compact car to a sport-utility vehicle).

With the image canvas displayed, the computing device displays a context menu of options to edit the image based on a selection of a segment by the user (step 205). In an implementation, the user selects a segment by clicking on the segment or by maneuvering a cursor to hover over the segment. When the computing device detects the user's interaction with a segment, the computing device surfaces editing options and/or suggestions for editing the image. As described above, the options may include modifications to the selected segment, to other, unselected segments, or to the entire image. As the user maneuvers the cursor around the image, the computing device surfaces suggestions and/or context menus for editing each segment as the cursor moves over it.

In various implementations, the image canvas may also include a graphical device that the user can select to perform an edit of the entire image. For example, when hovering over or selecting the canvas editing button, the computing device may display options for editing the entire image, such as to change the style of the image, to change the image size or proportions, to crop the image, and so on.

As the computing device receives selections by the user to edit the image or segments of the image, the computing device accesses various tools or models to perform the edits. To the user, the tool or engine performing the edit is hidden and the user sees only the result of the edit, thus streamlining the editing process by providing a consolidated menu of options for edits which may be performed by different components or services.

Referring again to FIG. 1, operational environment 100 includes a brief example of process 200 as employed by elements of operational environment 100 in an implementation. Computing device 110 executes application 120 including causing local user experiences 131(a)-(c) to be displayed via user interface 121. Application 120 may execute locally with respect to computing device 110, or computing device 110 may host application 120 which executes on one or more server computing devices remote from and in communication with computing device 110, or application 120 may execute in distributed, client-server fashion. User experiences 131(a)-(c) may be a chat interface by which the user can interact with application 120 and, through application 120, with generative AI model 150 with respect to image creation or editing.

In an operational scenario, application 120 hosted by computing device 110 receives image 143 to be edited in user interface 121. In various implementations, the image may be an image generated by generative AI model 150 based on the user's request in input 141 and selected by the user for editing. In some scenarios, however, image 143 may be uploaded to application 120 by the user.

When application 120 receives image 143, application 120 sends image 143 to segmentation model 170 for processing. Segmentation model 170 generates a segmentation map of image 143 which segments the image according to objects or regions detected by the model based on its semantic understanding of the image. Segmentation model 170 returns the segmentation map to application 120 which displays an image canvas of the image, depicted in various stages as intelligent image canvas 143(a) and 143(b) in user interface 121.

In user interface 121, the user can maneuver a cursor over intelligent image canvas 143(a) or 143(b) to select a particular segment of image 143. As the user moves the cursor over a segment of intelligent image canvas 143(a), the segment is highlighted to distinguish it from the rest of the image. For example, the segment may be shown in illuminated style with a bright border. In user experience 131(b), the user has selected a segment, and context menu 144(a) is surfaced which includes options for editing the selected segment or image. The user may select an option to edit the image or may continue to move the cursor around the image.

In user experience 131(c), the user has maneuvered the cursor over a different segment of image canvas 143(b). As depicted in intelligent image canvas 143(b), the user has positioned the cursor over the flower segment of the image. Context menu 144(b) is surfaced, displaying options for editing the selected segment or the image. The options presented in context menu 144(a) and 144(b) may be the same, or they may include editing options which are specific to the segment, such as options for regenerating the segment based on the classification or labeling of the segment made by segmentation model 170.

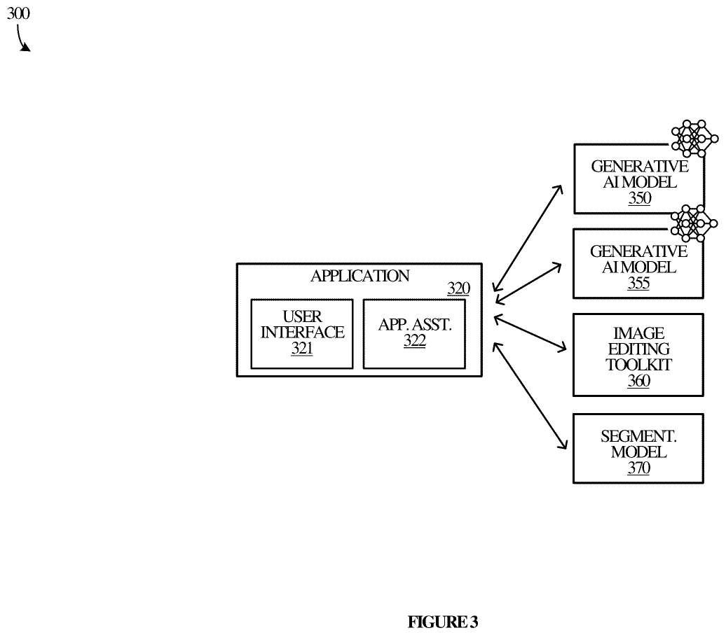

Turning now to FIG. 3, FIG. 3 illustrates operational architecture 300 for contextual editing of images in an implementation. Operational architecture 300 includes application 320, of which application 120 of FIG. 1 is representative, including user interface 321 and application assistant 322. Application 320 communicates with generative AI model 350 including sending prompts for generating or regenerating images. Application 320 also communicates with segmentation model 370 including sending an image to be mapped into segments and receiving a segmentation map of the image. Communication between application 320 and generative AI models 350 and 355 and segmentation model 370 may be transmitted via APIs hosted by the respective models. Application 320 also communicates with or accesses image editing toolkit 360 including various tools and filters for editing images.

Application 320 is representative of a software application including application assistant 322 for interfacing with generative AI models to generate and edit images. Application assistant 322 supports text-based or chat-type interaction with deep learning models, such as generative AI models and, in some scenarios, large language models, as well as visual editing of images using contextual editing menus. Application 320 may execute locally on a user computing device, such as a client or user computing device, or application 320 may execute on one or more servers in communication with a user computing device over one or more wired or wireless connections, causing user interface 321 to be displayed on a computing device, e.g., a user computing device. In some scenarios, application 320 may execute in a distributed fashion across client and server devices.

Generative AI models 350 and 355, of which generative AI model 150 is representative, are deep learning models trained to generate an image based on a textual prompt or to modify an image, including using context of the image to regenerate segments of the image (i.e., “inpaint” the image) or to expand the image (i.e., “outpaint” the image).

Segmentation model 370, of which segmentation model 170 is representative, is a deep learning model trained to map an image into segments based on a semantic understanding of the image.

Image editing toolkit 360 includes various tools and filters for editing images. Image editing toolkit may include tools for modifying visual characteristics of an image, such as color (e.g., hue, saturation, color balance, white balance), lighting, contrast, and focus (e.g., blur, sharpen), as well as rotating or flipping an image, retouching, and the like.

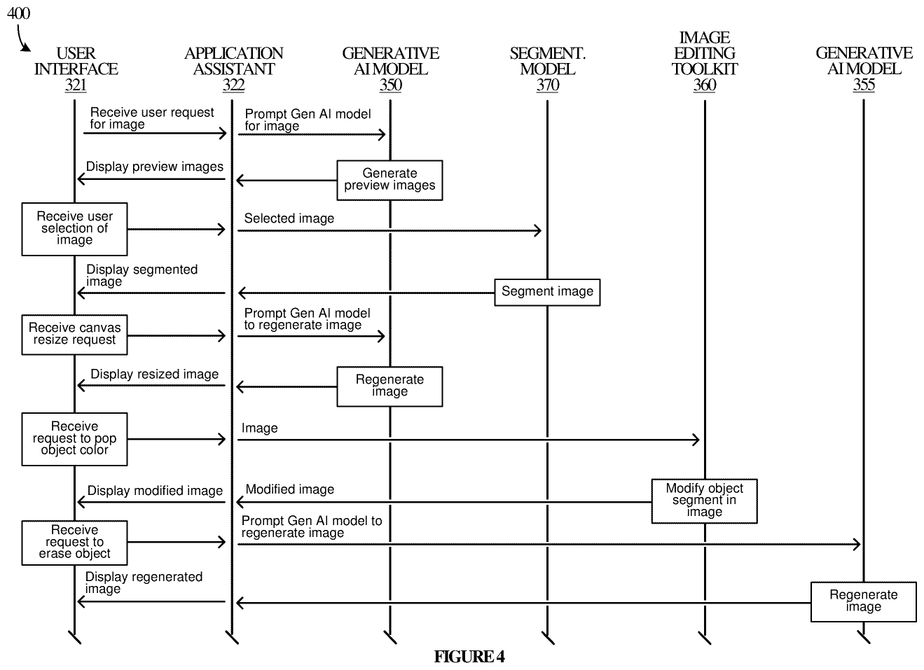

FIG. 4 illustrates operational scenario 400 for contextualized image editing in an implementation. In operational scenario 400, application assistant 322 receives request from a user for an image including the user's natural language description of the image. The request may be keyed into user interface 321 or spoken to a speech-to-text engine of the computing device on which user interface 321 is displayed which transcribes the user's speech to a text input in user interface 321. Application assistant 322 generates a prompt based on the user input which tasks generative AI model 350 with creating one or more images responsive to the user's request. Generative AI model 350 generates and returns the one or more images which are displayed in user interface 321.

In user interface 321, the user selects an image for editing. Application assistant 322 receives the selection and prompts segmentation model 370 to generate a segmentation map of the selected image. Segmentation model 370 generates and returns the segmentation map to application assistant 322. Application assistant 322 displays an image canvas based on the segmentation map in user interface 321. The image canvas enables the user to select a segment of the image canvas for editing and displays a context menu of options for editing the image when a segment is selected. The image canvas also includes selectable controls for editing the entire image.

With the image canvas displayed, user interface 321 receives a request from the user to resize the image. For example, as the user hovers the cursor over a selectable control for resizing the image, for example, from a square shape to a landscape image. In response to the user request, application assistant 322 generates a new prompt for generative AI model 350 which tasks the model with regenerating the image according to the user's request and includes the image to be resized. Generative AI model 350 regenerates the image in response to the prompt and returns the new image to application assistant 322. Application assistant 322 causes the resized image to be displayed in user interface 321.

Next, in operational scenario 400, user interface 321 receives user input indicating a request to perform a “color pop” edit on a selected segment of the image such that the unselected segments of the image are rendered in black and white while the selected segment remains colored, causing the object or area of the selected segment to be visually distinguished from the rest of the image. In response to the user input, application assistant 322 accesses the appropriate tool or engine of image editing toolkit 360 to perform the requested edit on the image. Application assistant 322 receives and displays the modified image in user interface 321.

Next, user interface 321 receives user input indicating a request by the user to erase an object from the image. In an implementation, the user selects a segment of the image and is presented with a context menu including an option to erase the segment. When the user selects the option to erase the segment, application assistant 322 generates a prompt which tasks generative AI model 355 with inpainting the area of the selected segment to effectively erase the object from the image. Upon receiving the edited image from generative AI model 355, application assistant 322 displays the image in user interface 321.

Operational scenario 400 may continue with the user making further edits to segments of the image or to the entire image. When the user has completed the process of visually editing the image in user interface 321, the user may select an option in application assistant 322 to save, send, export, print, or otherwise handle the finished image. For example, the user may insert the finished image in a project such as a document, slide presentation, or website.

In various implementations, the various editing options displayed in the contextual menus correspond to a model or editing tool, and the application executes the requested editing selection by sending the image to the corresponding model or editing using the corresponding tool. The application may also present options for editing a given segment based on contextual information about the segment received from the segmentation model. The application identifies a model or editing tool to perform an editing option of the given segment. When the editing option is selected, the application executes the edit by sending the image to the corresponding model or editing the image with the corresponding too.

the application performs the various editing option based on a correspondence determined by the application between

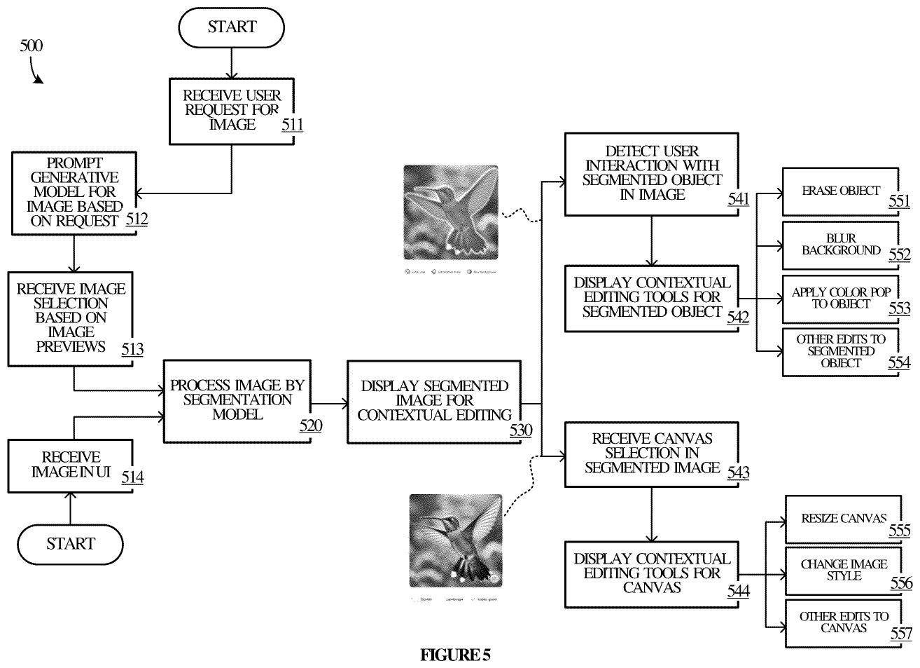

FIG. 5 illustrates workflow 500 for contextual editing of images in an implementation. In an implementation, workflow 500 is performed by an application which hosts a user interface for receiving text prompts from a user and for visual editing of images using contextual menus. Workflow 500 depicts two routes by which the editing process is initiated, however, other routes may also apply.

The application receives a natural language request from a user for an image in the user interface (step 511). The application prompts a generative AI model for image generation to create an image based on the user's request (step 512). The application receives a set of images from the generative AI model and displays the images, such as previews of the images, in the user interface. The application receives a selection of an image by the user in the user interface (step 513).

In an alternative method of initiating workflow 500, the application may receive an image for editing by the user submitting the image to the application via the user interface (step 514). For example, the image submitted by the user to the application may be an image previously generated by the generative AI model.

Continuing with workflow 500, when the application has an image selected or provided by the user, the application processes the image for display by prompting a segmentation model to generate a segmentation map of the image (step 520). As the segmentation model maps the image into segments, the application may display an interactive animation in the user interface to encourage the user to stay engaged with the application while the image is processed.

When the application receives the segmentation map of the image, the application displays the segmented image in the user interface for visual editing based on contextual menus of editing options (step 530). To edit the image, the user may interact with individual segment of the image (step 541), or the user may select to edit the whole image (step 543). For example, the image canvas may include a graphical button for displaying options for editing the entire image.

When the user selects an individual segment for editing, the application displays a contextual menu of editing tools for the selected segment (step 542). These editing tools can include erasing the object of the segment (step 551), blurring the background or unselected segments of the image while the selected segment remains unblurred (step 552), applying a color pop effect to the image causing the colors background or unselected segments of the image to be muted while the selected segment remains in color (step 553), or performing other edits with in relation to the selected segment.

When the user selects to edit the entire image, the application displays a contextual menu of editing tools for editing the entire image (step 544). These editing tools can include resizing the image, such as changing the image proportions (step 555), changing the artistic style of the image (step 556), or performing other edits which are applied to all of the segments of the image (step 557).

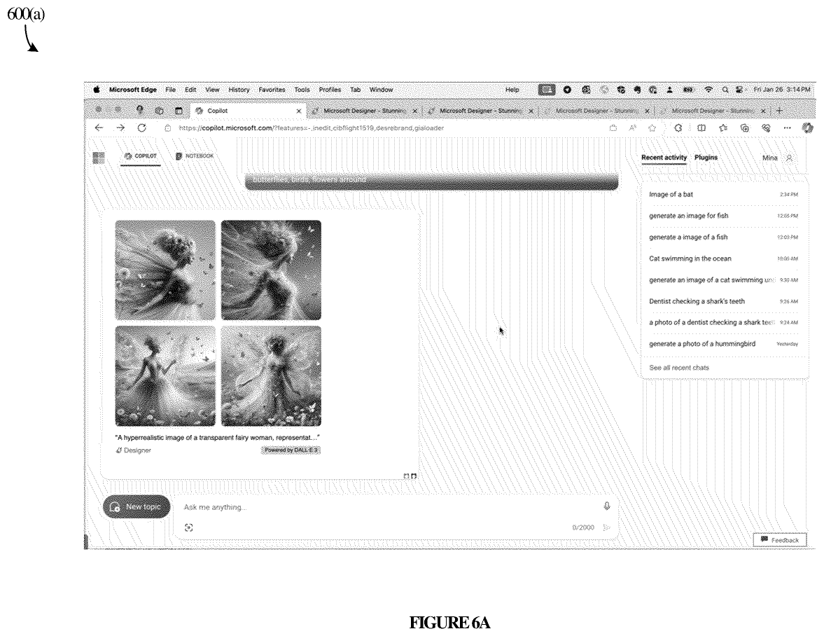

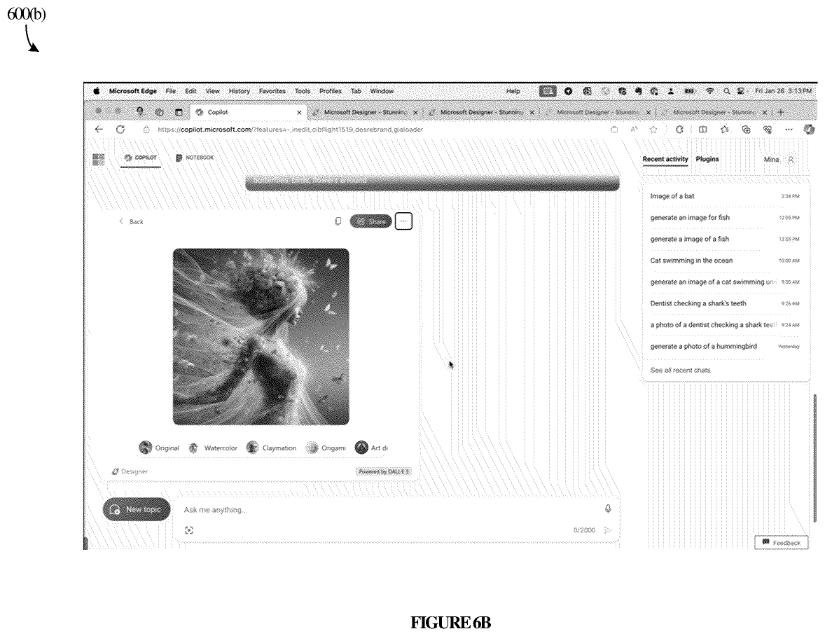

FIGS. 6A and 6B illustrate a user interface 600 (shown in various stages of operation as 600(a) and 600(b)) for receiving text prompts from a user and for visual editing of images using contextual menus in an implementation. In FIG. 6A, user interface 600(a) displays an array of images generated by a generative AI model based on the user's natural language input, “A hyperrealistic image of a transparent fairy woman, . . . .” When the user selects an image for editing, the application hosting user interface 600 sends the selected image to a segmentation model to obtain a segmentation map of the image.

In user interface 600(b) of FIG. 6B, an intelligent image canvas of the selected image is displayed in the user interface based on the segmentation map received from the segmentation model. As illustrated, with no segment selected, the application presents the user with a menu of options for editing the image as a whole, i.e., changing the artistic style of the image. User interface 600(b) also displays a text box by which the user can submit other textual input, such as an input which for performing an edit to the image. User interface 600(b) also includes a graphical button by which the user can interact with the generative AI model (via the application) to generate a new image or with other deep learning models, such as a large language model, to generate or receive other types of content.

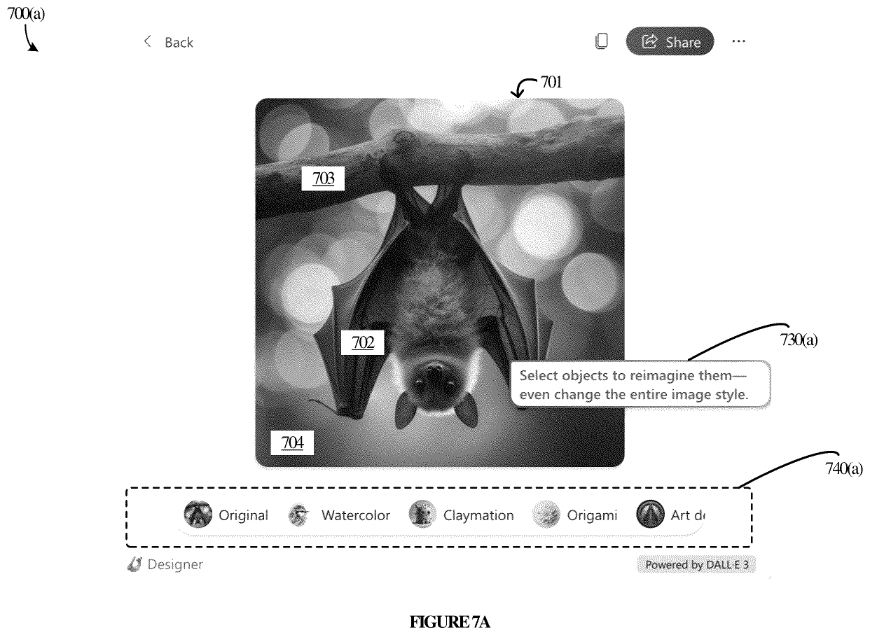

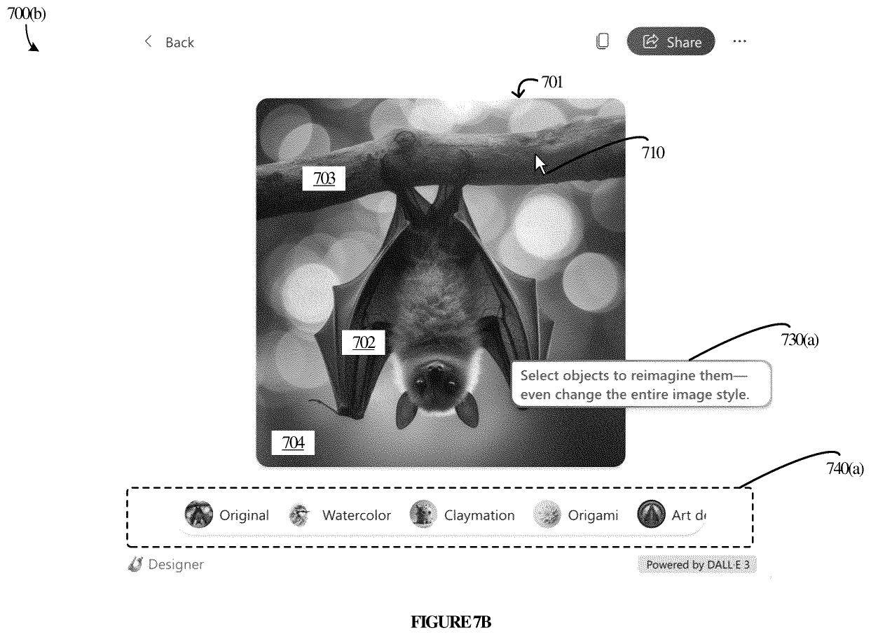

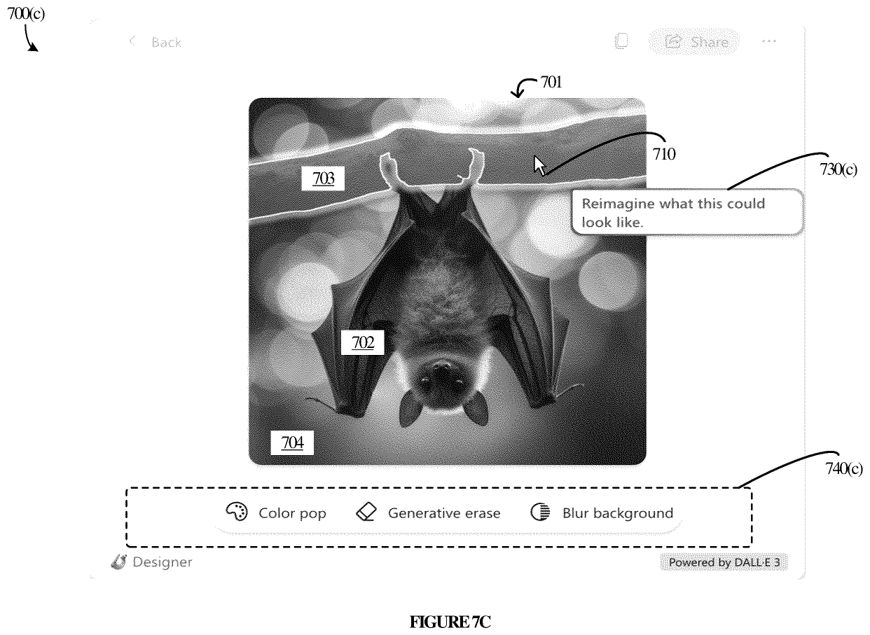

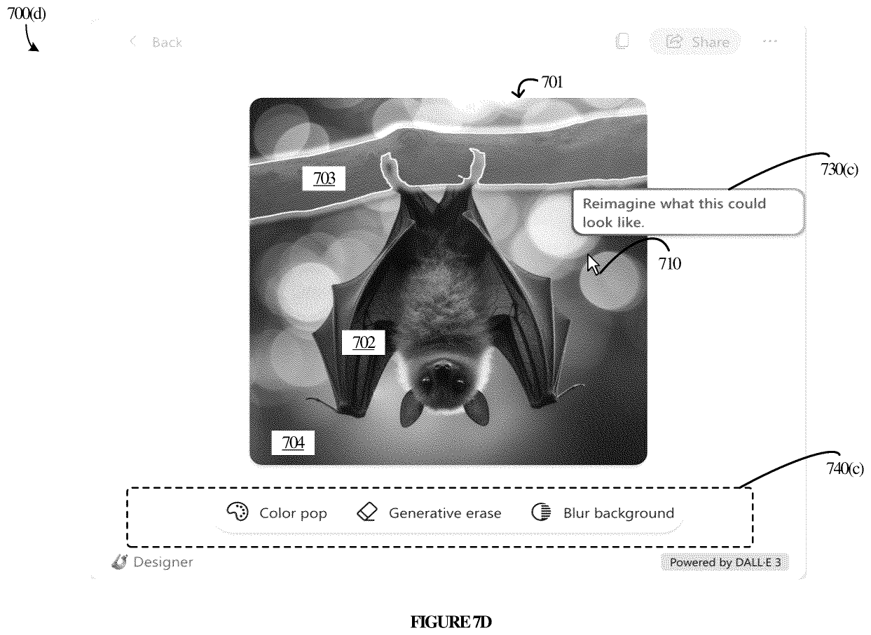

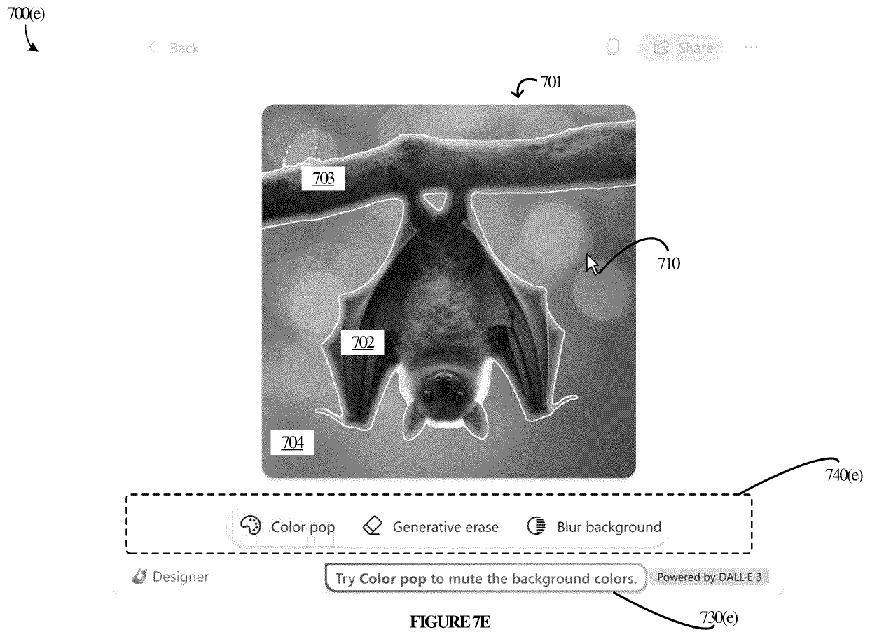

FIGS. 7A-7E illustrate a user interaction in user interface 700 (shown in various stages of operation as 700(a)-(e)) for receiving text prompts from a user and for visual editing of images using contextual menus in an implementation. In user interface 700(a), image canvas 701 including three segments (bat 702, branch 703, and background 704) is displayed which the user can visually edit by maneuvering a pointer or cursor over image canvas 701. At the onset of editing, the application hosting user interface 700 causes the display of editing suggestion 730(a) for the beginning stage of the editing process. With no segment selected by the user, user interface 700(a) also displays contextual menu 740(a) of options for editing the image as a whole.

Continuing to user interface 700(b) of FIG. 7B, the user maneuvers cursor 710 over branch segment 703 of image canvas 701.

In user interface 700(c) of FIG. 7C, with the cursor 710 on branch segment 703, the segment is made visually distinct from the rest of image canvas 701 and editing suggestion 730(c) for branch segment 703 is displayed. When the user selects (e.g., clicks on) branch segment 703, contextual menu 740(c) of options for editing the image or the segment are displayed, including “Color Pop,” “Generative erase,” and “Blur background.” Depending on which option the user selects, the application uses a particular model or tool corresponding to selected edit to revise the image. For example, if the user selects “Color pop,” the application may use an image editing tool for muting the color of background segments of the image based on identification of foreground, midground, and background segments in the segmentation map. Similarly, if the user elects to blur the background, the application may apply a blurring effect or filter to the segments of the image identified as background segments in the segmentation map. If the user instead chooses “Generative erase,” the application sends the image to a generative AI model and prompts the model to inpaint the selected segment by inferring the segment content based on the surrounding content.

Continuing to FIG. 7D, in user experience 700(d), the user maneuvers cursor 710 onto background segment 704 of image canvas 701 which encompasses the background of the image.

In user experience 700(e) of FIG. 7E, with cursor 710 on background segment 704, the segment is made visually distinct from the rest of the segments of image canvas 701, and a new editing suggestion 730(e) for the segment is displayed based on the type of the selected segment. The type of the selected segment (e.g., a background type of segment) is contextual information about the segment which the application obtains from the segmentation map. (Similarly, if the user had clicked on bat segment 702, the application may display a contextual menu based on the segment being a foreground type of segment.) When the user clicks on background segment 704, the application displays contextual menu 730(e) for editing the image to achieve a certain effect with respect to background segment 704. In user experience 700(e), when the user clicks on background segment 704, the user can then maneuver cursor 710 to select an editing option in contextual menu 730(e). In some scenarios, the contextual menu may include other editing options which are specific to the type of segment that the user has selected. For example, an option for editing background segment 704 may include refilling or regenerating the segment to display a different type of content, e.g., a night sky.

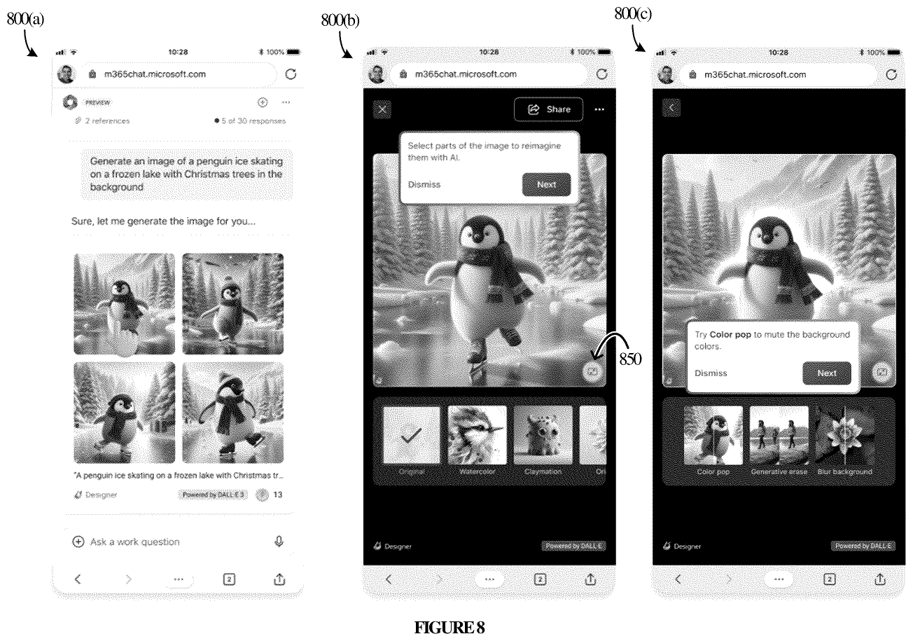

FIG. 8 illustrates user interface 800 (shown in various stages of operation as 800(a)-(c)) for visual editing of images on a mobile computing device with a touchscreen in an implementation. User interface 800(a) displays a natural language request for an image received from a user and a natural language response generated by the application hosting the user interface. Based on the user's request, in user interface 800(a), the user is presented with an array of images generated by a deep learning model in response to the user's natural language input.

In user interface 800(b), the image selected by the user is displayed as an intelligent image canvas which the user can visually edit. The image canvas includes button 850 in the lower right corner by which the user can elect to view editing options for editing the image as a whole (e.g., resizing the image, changing the style of the image). Below the image is the contextual menu of options to edit the image along with sample images illustrating the various artistic styles that may be applied to the image.

In user interface 800(c), the user has selected the penguin in the foreground of the image by touching the penguin segment of the image canvas. With penguin segment selected, the application surfaces a contextual menu of editing options for editing the image relative to the selected segment to achieve a particular effect. For example, to make the selected image stand out, the contextual menu presents options to apply a color pop effect to the image or to blur the background of the image. Other options for editing a selected segment may be presented. The user may elect to modify a selected segment, such as erasing the selected segment or regenerating the selected segment to modify the object or to replace the object with a different object. For example, the contextual menu may present the user with the option to change the penguin to another species or to change the activity of the penguin from skating to, say, sledding based on contextual information about the image provided in the segmentation map.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements contextual editing process 906, which is (are) representative of the contextual processes discussed with respect to the preceding Figures, such as process 200 and workflow 500. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including contextual editing process 906) may be implemented in program instructions and among other functions may, when executed by processing system 902, direct processing system 902 to operate as described with respect to the various operational scenarios, sequences, and processes illustrated herein. For example, software 905 may include program instructions for implementing a contextual editing process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support contextual editing of an image in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive an image generated by a generative artificial intelligence (AI) model in response to a prompt, wherein the prompt includes a natural language request from a user;
display an image canvas of the image comprising multiple segments of the image identified by a segmentation model; and
display a context menu of options to edit the image based on a selection of a segment of the image by the user.

2. The computing apparatus of claim 1, wherein the program instructions further direct the computing apparatus to display a second context menu of options to edit the image based on a selection of a canvas editing button by the user.

3. The computing apparatus of claim 1, wherein the context menu comprises options based on a semantic understanding of the segment identified by the segmentation model.

4. The computing apparatus of claim 3, wherein the program instructions further direct the computing apparatus to receive a selection of a second segment of the image by the user and to display a second context menu of options to edit the image, wherein the second context menu includes at least one option to edit the image that is different from the options of the context menu.

5. The computing apparatus of claim 3, wherein the program instructions further direct the computing apparatus to prompt the generative AI model to regenerate the image based on a selection by the user of an option in the context menu.

6. The computing apparatus of claim 1, wherein to display the context menu of options, the program instructions further direct the computing apparatus to identify an option for display based on contextual information about the segment received from the segmentation model.

7. The computing apparatus of claim 1, wherein the program instructions further direct the computing apparatus to identify a generative AI model or editing tool for each option of the context menu of options to edit the segment.

8. The computing apparatus of claim 1, wherein to display the image canvas, the program instructions further direct the computing apparatus to visually differentiate the segment selected by the user from other segments of the multiple segments of the image.

9. A method of operating a computing device comprising:
receiving an image generated by a generative artificial intelligence (AI) model in response to a prompt, wherein the prompt includes a natural language request from a user;
displaying an image canvas of the image comprising multiple segments of the image identified by a segmentation model; and
displaying a context menu of options to edit the image based on a selection of a segment of the image by the user.

10. The method of claim 9, wherein the context menu comprises options based on a semantic understanding of the segment identified by the segmentation model.

11. The method of claim 10, further comprising receiving a selection of a second segment of the image by the user and displaying a second context menu of options to edit the image, wherein the second context menu comprises an option to edit the image that is different from the options of the context menu.

12. The method of claim 11, further comprising prompting the generative AI model to regenerate the image based on a selection by the user of an option in the context menu.

13. The method of claim 12, wherein displaying the context menu of options comprises identifying an option for display based on contextual information about the segment received from the segmentation model.

14. The method of claim 9, further comprising identifying a generative AI model or image editing tool for each option of the context menu of options to edit the segment.

15. The method of claim 12, wherein displaying the image canvas comprises visually differentiating the segment selected by the user from other segments of the multiple segments of the image.

16. One or more computer readable storage media having program instructions stored thereon that, when executed by one or more processors, direct a computing apparatus to at least:
receive an image generated by a generative artificial intelligence (AI) model in response to a prompt, wherein the prompt includes a natural language request from a user;
display an image canvas of the image comprising multiple segments of the image identified by a segmentation model; and
display a context menu of options to edit the image based on a selection of a segment of the image by the user.

17. The one or more computer readable storage media of claim 16, wherein the context menu comprises options based on a semantic understanding of the segment identified by the segmentation model.

18. The one or more computer readable storage media of claim 17, further comprising receiving a selection of a second segment of the image by the user and displaying a second context menu of options to edit the image, wherein the second context menu comprises an option to edit the image that is different from the options of the context menu.

19. The one or more computer readable storage media of claim 18, wherein the program instructions further direct the computing apparatus to prompt the generative AI model to regenerate the image based on a selection by the user of an option in the context menu.

20. The one or more computer readable storage media of claim 16, wherein the program instructions further direct the computing apparatus to identify an option for editing the selected segment for display in the context menu based on contextual information about the segment received from the segmentation model.
